(19) United States
(12) Patent Application Publication
(10) Pub. No.: US 2015/0194649 A1
(43) Pub. Date: Jul. 9, 2015

(54) SELF-CONTAINED BATTERY CELL PACKAGING FOR FLEXIBLE ARRANGEMENTS AND THERMAL MANAGEMENT

(71) Applicant: EnerDel, Inc., Greenfield, IN (US)

(72) Inventors: Kelly B. Ledbetter, Carmel, IN (US); Khosrow Nematollahi, Carmel, IN (US); Xinbao Gao, Carmel, IN (US); Wendell G. Ferguson, Daleville, IN (US); Douglas E. Lasley, Middletown, IN (US)

(21) Appl. No.: 14/664,643

(22) Filed: Mar. 20, 2015

Related U.S. Application Data
(63) Continuation of application No. PCT/US13/60804, filed on Sep. 20, 2013.
(60) Provisional application No. 61/776,085, filed on Mar. 11, 2013.
(60) Provisional application No. 61/703,469, filed on Sep. 20, 2012.

(51) Int. Cl. H01M 2/10; H01M 10/0525

(52) U.S. Cl. CPC H01M 2/1072; H01M 10/625; H01M 10/0525; H01M 2220/20

(57) ABSTRACT

A multi-cell battery system is provided including one or more independent, self-contained, modular battery sub-assemblies. A desired number of sub-assemblies may be assembled together in a desired arrangement to produce a custom battery system. Adjacent battery sub-assemblies may cooperate to receive a heat exchange medium for thermal management of the battery system.

### CROSS REFERENCE TO RELATED APPLICATION

This application claims priority to U.S. Provisional Patent Application Ser. No. 61/776,085, filed Mar. 11, 2013, and to U.S. Provisional Patent Application Ser. No. 61/703,469, filed Sep. 20, 2012, the disclosures of which are hereby expressly incorporated by reference herein in their entirety.

### FIELD OF THE DISCLOSURE

The present disclosure relates to a battery system. More particularly, the present disclosure relates to a multi-cell battery system, and to a method for assembling the same.

### BACKGROUND OF THE DISCLOSURE

A plurality of battery cells, such as lithium-ion battery cells, may be stacked together to form a multi-cell battery system. In U.S. Patent Application Publication No. 2012/0021271 to Topic et al., for example, a battery system is disclosed with a stacked arrangement of battery cells and frames. After stacking together individual components of the battery system, the components may be held together using tie rods, for example.

Such battery systems may be rechargeable. Repeated charging and discharging of the battery system to power a desired application generates heat, so a cooling system may be provided to remove heat from the battery system. The above-described battery system of U.S. Patent Application Publication No. 2012/0021271 to Topic et al. utilizes heat sinks for cooling, for example.

### SUMMARY

The present disclosure provides a multi-cell battery system that includes one or more independent, self-contained, modular battery sub-assemblies. A desired number of sub-assemblies may be assembled together in a desired arrangement to produce a custom battery system. Adjacent battery sub-assemblies may cooperate to receive a heat exchange medium for thermal management of the battery system.

According to an embodiment of the present disclosure, a battery system is provided including at least one battery sub-assembly. The at least one battery sub-assembly includes at least one battery cell, a first frame having an inner surface that faces the at least one battery cell and an outer surface opposite the inner surface, and a second frame having an inner surface that faces the at least one battery cell and an outer surface opposite the inner surface, wherein the inner surfaces of the first and second frames are welded together to compress the at least one battery cell.

According to another embodiment of the present disclosure, a battery system is provided including at least one battery sub-assembly. The at least one battery sub-assembly includes at least one battery cell, a first frame having a first outer periphery, a first central region, a first inner surface that faces the at least one battery cell and a first outer surface apposite the first inner surface, the first outer surface of the first frame having a first recess located in the first central region and a first protrusion located in the first central region that interact with a first adjacent battery sub-assembly, and a second frame having a second outer periphery, a second central region, a second inner surface that faces the at least one battery cell and a second outer surface opposite the second inner surface, the second outer surface of the second frame having a second recess located in the second central region and a second protrusion located in the second central region that interact with a second adjacent battery sub-assembly.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a partially assembled perspective view of an exemplary battery system of the present disclosure, the battery system including a first end support, a second end support, a plurality of battery sub-assemblies positioned between the first and second end supports, the battery system further including a plurality of external bands shown spaced apart from the battery system;

FIG. 2 is an exploded perspective view of the battery system of FIG. 1, the first and second end supports shown spaced apart from the plurality of battery sub-assemblies;

FIG. 3 is a schematic view of a housing around the battery system of FIG. 1;

FIG. 4 is a cross-sectional view of the battery sub-assemblies of FIG. 2, taken along line 4-4 of FIG. 2;

FIG. 5 is a plan view of a frame piece of a battery sub-assembly of FIG. 4;

FIG. 6A is a perspective view of the frame piece of FIG. 5 rotated for use as a right frame of a battery sub-assembly;

FIG. 6B is a perspective view similar to FIG. 6A showing the same frame piece rotated for use as a left frame of the battery sub-assembly; and

FIGS. 7A-7D are plan views of alternative frame pieces for use in the battery sub-assembly.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

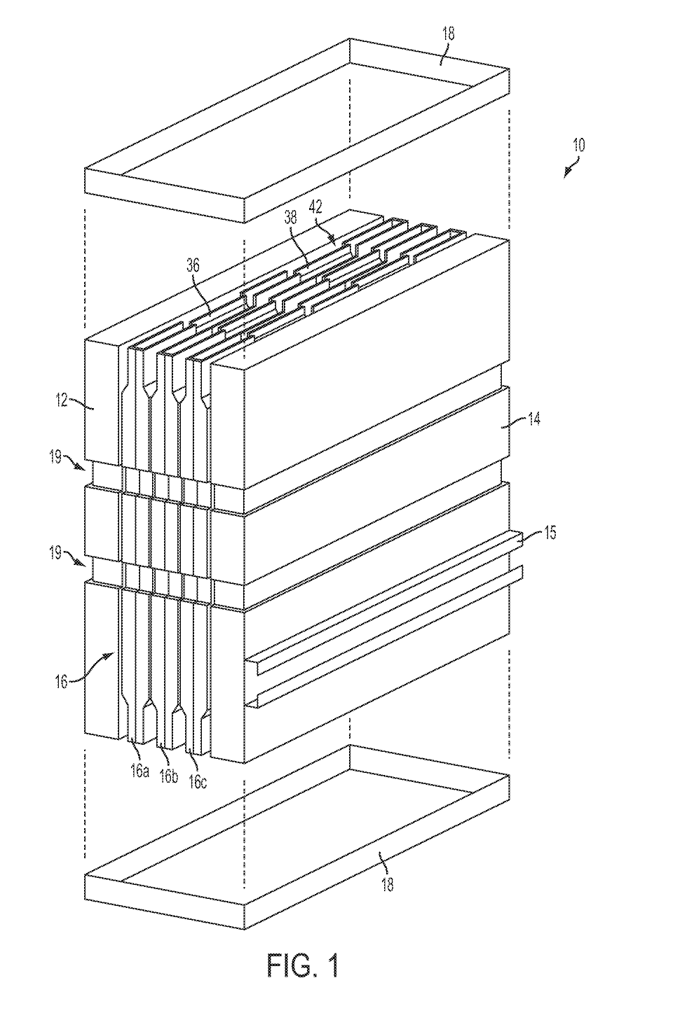

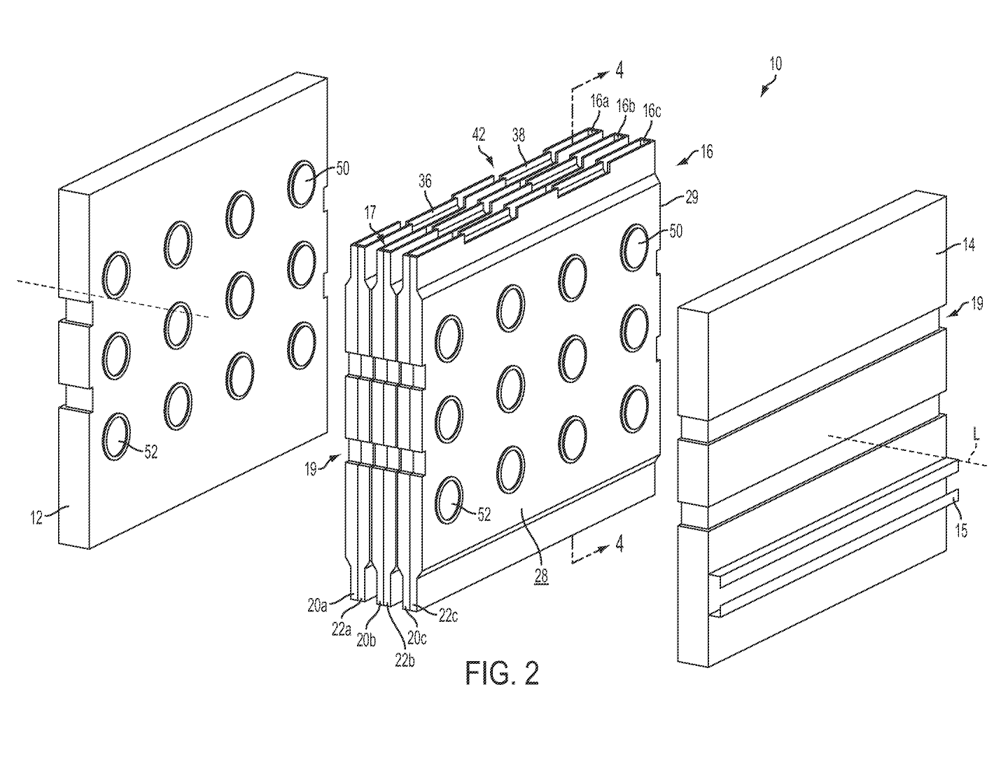

An exemplary multi-cell battery system 10 is shown in FIGS. 1 and 2. Battery system 10 may include a plurality of secondary (rechargeable) or non-rechargeable battery cells, as discussed further below. Battery system 10 may be used in a hybrid vehicle or an electric vehicle, for example, serving as a power source that drives an electric motor of the vehicle. Battery system 10 may also store and provide energy to other devices which receive power from batteries, such as the stationary energy storage market. Exemplary applications for the stationary energy storage market include providing power to a power grid, providing power as an uninterrupted power supply, and other loads which may utilize a stationary power source. In one embodiment, battery system 10 may be implemented to provide an uninterrupted power supply for computing devices and other equipment in data centers. A controller of the data center or other load may switch from a main power source to an energy storage system of the present disclosure based on one or more characteristics of the power being received from the main power source or a lack of sufficient power from the main power source.

The illustrative battery system 10 of FIGS. 1 and 2 includes a first end support 12, a second end support 14 opposite the first end support 12, and at least one battery sub-assembly 16 positioned between the first and second end supports 12, 14. Battery system 10 also includes at least one support 18 that holds first and second end supports 12, 14 and battery sub-assemblies 16 together. Each component of the battery system 10 is described further below with continued reference to FIGS. 1 and 2.

First and second end supports 12, 14 of battery system 10 are arranged at opposite ends of the battery system 10 to protect and hold together the battery sub-assemblies 16 positioned therebetween. First and second end supports 12, 14 are illustratively rectangular in shape, although the shape may vary. First and second end supports 12, 14 may be constructed of plastic, metal, or another suitable material. Although not illustrated in FIGS. 1 and 2, each end support 12, 14 may include a mounting structure for mounting the battery system 10 in place. If, for example, the battery system 10 will be used to power a vehicle, each end support 12, 14 may include one or more rails 15 or other suitable mounting brackets for mounting the battery system 10 to the chassis of the vehicle.

Battery sub-assemblies 16 of battery system 10 are stacked together along a longitudinal axis L. Each battery sub-assembly 16 is generally rectangular in shape, although the shape may vary. Each battery sub-assembly 16 is oriented in a direction generally perpendicular to the longitudinal axis L, as shown in FIG. 2, with adjacent battery sub-assemblies 16 being oriented generally parallel to one another. Adjacent battery sub-assemblies 16 are at least partially spaced apart to define cooling gaps 17 therebetween, as discussed further below. The number of battery sub-assemblies 16 in the battery system 10 may vary depending on the desired application from as few as 1, 2, 3, 4, or 5 battery sub-assemblies 16 to as many as 10, 15, 20, 25, or 30 battery sub-assemblies 16, or more, or within any range defined between any pair of the foregoing values. The illustrative battery system 10 includes 3 battery sub-assemblies 16a, 16b, 16c.

Supports 18 of battery system 110 illustratively include external bands that wrap around battery system 10. External bands 18 may be constructed of metal or another inflexible material. Each external band 18 has a predetermined size (e.g., a predetermined length) to control the corresponding size of battery system 10 (e.g., the corresponding length along longitudinal axis L). When the external bands 18 are wrapped and secured around battery system 10, such as by welding an elongate band into a closed loop, the battery sub-assemblies 16a, 16b, 16c may become compressed together between the first and second end supports 12, 14. As shown in FIGS. 1 and 2, first and second end supports 12, 14, and sub-assemblies 16a, 16b, 16c cooperate to define external grooves 19 for receiving corresponding external bands 18 around battery system 10. Other suitable supports 18 include internal tie rods, for example. In this case, first and second end supports 12, 14, and sub-assemblies 16a, 16b, 16c may cooperate to define internal channels for receiving the tie rods through battery system 10.

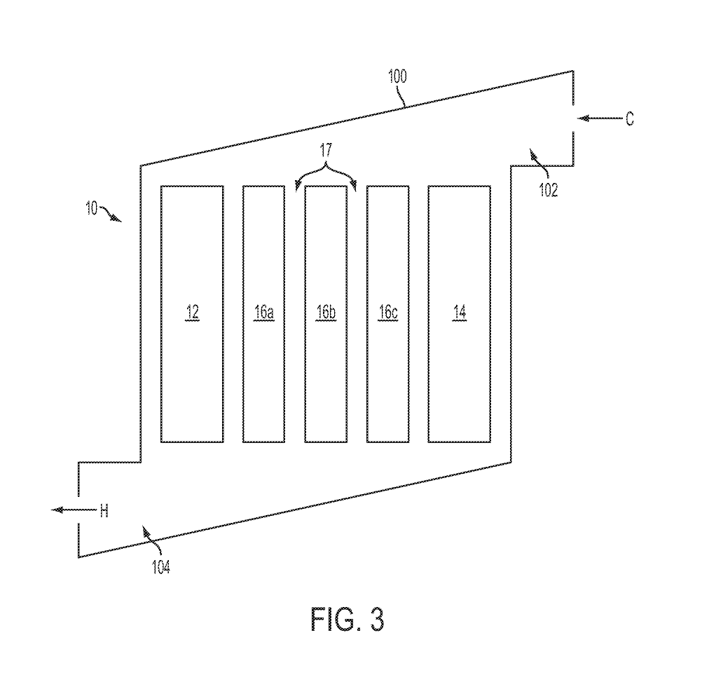

Referring next to FIG. 3, a housing 100 may be provided around battery system 10 to protect battery system 10 and to facilitate cooling of battery system 10. Housing 100 may include an inlet plenum or conduit 102 that directs a cool heat exchange medium C toward battery system 10, and more specifically into gaps 17 between battery sub-assemblies 16a, 16b, 16c of battery system 10. The cool heat exchange medium C may travel through battery system 10 to withdraw heat from battery sub-assemblies 16a, 16b, 16c by convection. Housing 100 may also include an outlet plenum or conduit 104 that directs the heated heat exchange medium H away from battery system 10. To encourage the heat exchange medium to travel through gaps 17 of battery system 10, the inlet conduit 102 of housing 100 may converge or narrow as it moves toward gaps 17, while the outlet conduit 104 of housing 100 may diverge or widen as it moves away from gaps 17, as shown in FIG. 3. It is also within the scope of the present disclosure that gaps 17 themselves may converge. The heat exchange medium may be in the form of a vapor (e.g., an air stream) or a fluid (e.g., a water/ethylene glycol stream). The heat exchange medium may be pushed or pulled through housing 100 and across battery system 10 by a suitable fan or pump, for example.

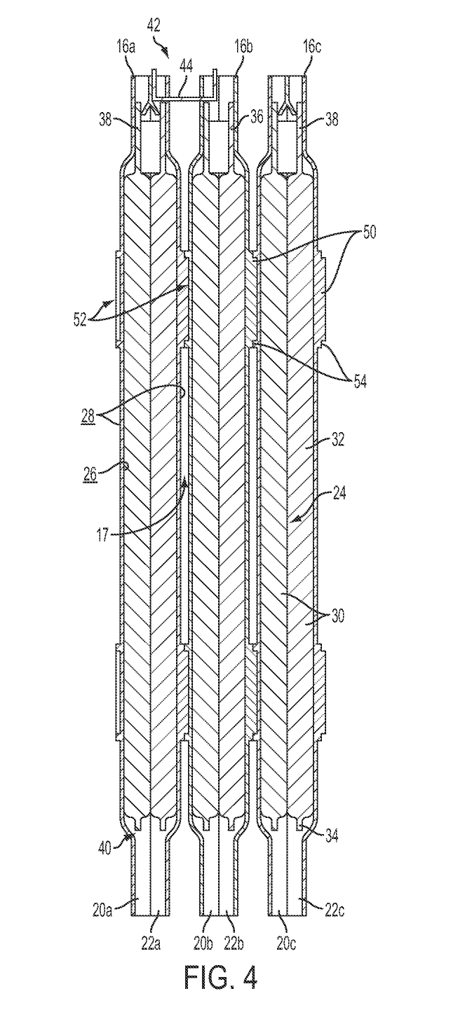

Battery sub-assemblies 16a, 16b, 16c of battery system 10 are shown in more detail in FIG. 4. Each battery sub-assembly 16a, 16b, 16c illustratively includes a corresponding first frame 20a, 20b, 20c, and a corresponding second frame 22a, 22b, 22c opposite the first frame 20a, 20b, 20c. In FIG. 4, the first frames 20a, 20b, 20c are positioned on the left side of each battery sub-assembly 16a, 16b, 16c and the second frames 22a, 22b, 22c are positioned on the right side of each battery sub-assembly 16a, 16b, 16c. For clarity, first frames 20a, 20b, 20c are referred to below as “left” frames, and second frames 22a, 22b, 22c are referred to below as “right” frames. However, the use of these terms is not intended to be limiting, as the frames 20, 22 may have any suitable orientation in use.

When assembled, each left frame 20 cooperates with a corresponding right frame 22 to define an internal space or receptacle 24 for receiving one or more battery cells 30 therebetween. In this arrangement, battery cells 30 are sandwiched together between corresponding left and right frames 20, 22, as shown in FIG. 4. Each battery sub-assembly 16 of FIG. 4 includes two battery cells 30, but this number may vary. In certain embodiments, foam strips (not shown) or other suitable spacers may be positioned between battery cells 30 of each sub-assembly 16.

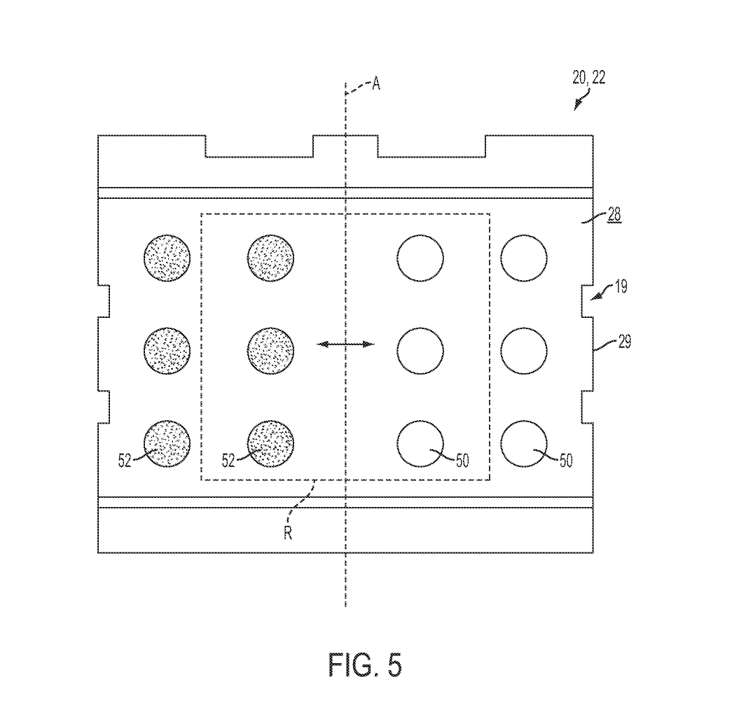

Each left and right frame 20, 22 is illustratively rectangular and generally planar in shape, although this shape may vary. As shown in FIG. 4, each left and right frame 20, 22 includes an inner surface 26 that faces receptacle 24 and the battery cells 30 therein and an outer surface 28 opposite the inner surface 26. As shown in FIG. 5, each left and right frame 20, 22 also includes a generally rectangular outer periphery 29. The above-described grooves 19 for external bands 18 (FIG. 1) are illustratively formed in outer peripheries 29 of left and right frames 20, 22. Within outer periphery 29, such as within central region R identified in FIG. 5, each left and right frame 20, 22, may have a generally solid construction that lacks openings between inner surface 26 and outer surface 28. Left and right frames 20, 22, may be constructed of plastic, metal, or another suitable material.

The interfacing inner surfaces 26 of corresponding left and right frames 20, 22 may physically interact with one another to control the relative orientation and rotation between left and right frames 20, 22. In one embodiment, posts or protrusions (not shown) on left frame 20 may be received within corresponding recesses (not shown) on right frame 22. In this way, the posts and recesses may serve as alignment guides or locators to facilitate assembly of left and right frames 20, 22. Also, the posts and recesses may minimize lateral movement between left and right frames 20, 22, thereby providing stability and rigidity to each sub-assembly 16. The proper orientation of left and right frames 20, 22 may ensure that battery cells 30 are properly concealed between left and right frames 20, 22, as shown in FIG. 4.

According to an exemplary embodiment of the present disclosure, corresponding left and right frames 20, 22 are coupled together around battery cells 30 by welding and without the use of external fasteners (e.g., screws). Avoiding external fasteners may minimize the weight of sub-assembly 16. Suitable welding techniques include ultrasonic welding, laser welding, and resistance welding, for example. These welding techniques may involve melting left and right frames 20, 22 and then allowing the molten material to cool and coalesce to form a strong, integral joint. The welds may be formed at spaced-apart locations across the interfacing inner surfaces 26 near outer peripheries 29 of left and right frames 20, 22. To achieve compression of battery cells 30 therebetween, left and right frames 20, 22 may be pressed together (e.g., clamped together) during the welding process.

Each individual sub-assembly 16 may be pre-assembled around battery cells 30 before being distributed commercially. In this manner, each sub-assembly 16 may form an independent, self-contained, modular unit of battery system 10. The pre-assembled nature of each sub-assembly 16 may facilitate the transportation, storage, and purchasing of individual sub-assemblies 16 and the subsequent assembly of battery system 10. For example, a customer may order sub-assemblies 16, store the sub-assemblies 16, and then assemble a desired number of the sub-assemblies 16 in a desired arrangement to produce a custom battery system 10. The pre-assembled nature of each sub-assembly 16 may also protect battery cells 30 from damage caused by the environment or human tampering, for example.

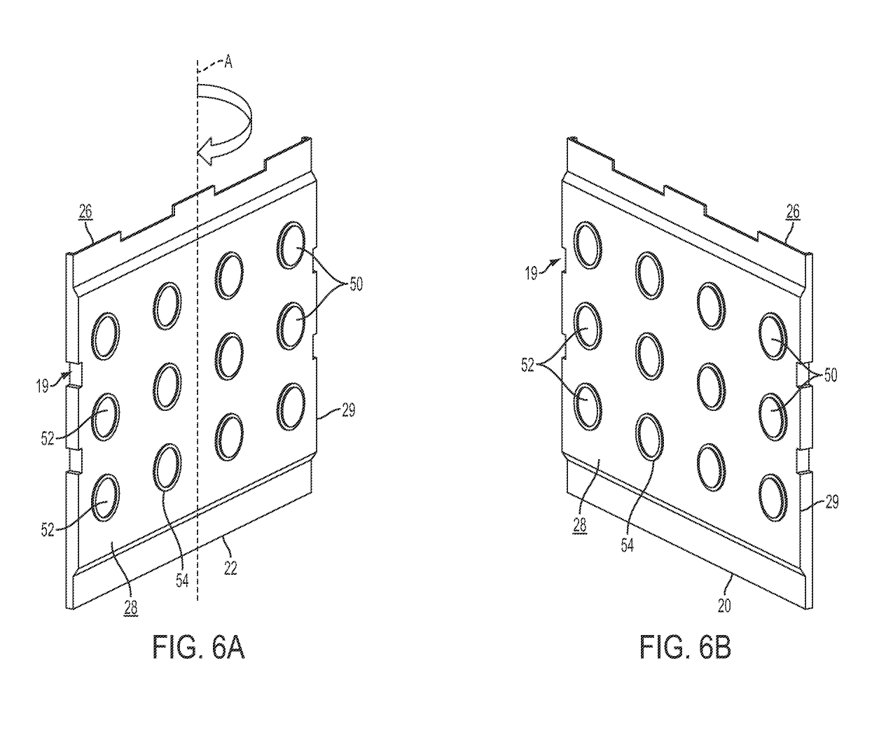

According to another exemplary embodiment of the present disclosure, left frames 20 are identical or substantially identical in size and shape to right frames 22. As shown in FIG. 6A, a frame piece is shown with its outer surface 28 facing to the right for use as a right frame 22. In FIG. 6B, the same frame piece is rotated about 180 degrees about an axis of rotation A so that outer surface 28 faces to the left for use as a left frame 20. The ability to use the same frame piece as both left frame 20 and right frame 22 may reduce manufacturing and inventory costs, for example.

Returning to FIG. 4, exemplary battery cells 30 for use in battery system 10 include prismatic, lithium-ion cells, for example. Battery cells 30 are illustratively rectangular and planar in shape, although this shape may vary. Each battery cell 30 includes an inner body portion 32 and an outer seal portion 34 surrounding the body portion 32. The inner body portion 32 of each battery cell 30 may be located within outer periphery 29 of each left and right frame 20, 22 to generally align with central region R of each left and right frame 20, 22 (FIG. 5), whereas the outer seal portion 34 of each battery cell 30 may be located near outer periphery 29 of each left and right frame 20, 22. According to an exemplary embodiment of the present disclosure, left and right frames 20, 22 include guide slots 40 that receive battery cells 30. More particularly, and as shown in FIG. 4, guide slots 40 receive the outer seal portions 34 of battery cells 30. The interaction between battery cells 30 and guide slots 40 may ensure proper orientation of battery cells 30 within left and right frames 20, 22. Also, guide slots 40 may be chamfered to guide insertion of battery cells 30 into guide slots 40.

Each battery cell 30 further includes a positive electrical contact or tab 36, and a negative electrical contact or tab 38. Positive and negative tabs 36, 38 illustratively extend from the same side of each battery cell 30, but it is also within the scope of the present disclosure that positive and negative tabs 36, 38 may extend from opposing sides of each battery cell 30. For example, positive tab 36 may extend upward from battery cell 30, and negative tab 38 may extend downward from battery cell 30. Corresponding left and right frames 20, 22 may cooperate to define openings 42 in outer periphery 29 through which positive and negative tabs 36, 38 extend. Because positive and negative tabs 36, 38 illustratively extend from the same side of each battery cell 30, openings 42 are also located on the same side of each battery sub-assembly 16. In embodiments where positive and negative tabs 36, 38 extend from opposing sides of each battery cell 30, openings 42 would likewise be located on opposing sides of each battery sub-assembly 16.

Positive and negative tabs 36, 38 of battery cells 30 in the same sub-assembly 116 and/or adjacent sub-assemblies 16 may be electrically connected in parallel or series. Desired electrical connections may be achieved by coupling an electrical connector 44 (e.g., a U-shaped copper bus) between desired tabs 36, 38 of desired battery cells 30. Electrical connectors 44 may be coupled to tabs 36, 38 by ultrasonic welding, for example, or by another suitable coupling technique. Ultimately, the electrical connectors 44 between battery cells 30 may be electrically coupled to positive and negative terminals (not shown) of battery system 10 for charging and discharging battery system 10. According to an exemplary embodiment of the present disclosure, a plurality of electrical connectors 44 may be pre-assembled on a board (not shown) to achieve a fast and accurate alignment between electrical connectors 44 and battery cells 30.

As discussed above, the interfacing inner surfaces 26 of left and right frames 20, 22 of each sub-assembly 16 may interact physically with one another. For example, with respect to the first subassembly 16a of FIG. 4, inner surface 26 of left frame 20a may interact physically with the interfacing inner surface 26 of right frame 22a. Physical interaction may also occur between outer surfaces 28 of adjacent sub-assemblies 16. For example, in FIG. 4, the outer surfaces 28 of the adjacent first and second sub-assemblies 16a, 16b may interact physically with one another, and the outer surfaces 28 of the adjacent second and third sub-assemblies 16b, 16c may interact physically with one another. Such physical interaction may control the relative orientation and rotation between adjacent sub-assemblies 16. Also, such physical interaction may minimize lateral movement between adjacent sub-assemblies 16, thereby providing stability and rigidity to adjacent sub-assemblies 16.

In one embodiment, the physical interaction between adjacent sub-assemblies 16 is achieved with posts or protrusions 50 on one sub-assembly 16 and corresponding recesses 52 on the adjacent sub-assembly 16. In FIG. 4, for example, posts 50 on the first sub-assembly 16a are received in corresponding recesses 52 of the adjacent second sub-assembly 16b, and posts 50 on the second sub-assembly 16b are received in corresponding recesses 52 of the adjacent third sub-assembly 16c. In this manner, the posts 50 and recesses 52 may serve as alignment guides or locators to facilitate assembly of adjacent sub-assemblies 16a, 16b, 16c. Also, the posts 50 and recesses 52 may provide a snug friction fit between adjacent sub-assemblies 16a, 16b, 16c. Similar posts 50 and recesses 52 may also be provided on end supports 12, 14, as shown in FIG. 2, to stabilize the connection between sub-assembly 16a and its adjacent first end support 12 and between sub-assembly 16c and its adjacent second end support 14. Furthermore, the posts 50 and recesses 52 may create metered cooling gaps 17 between adjacent sub-assemblies 16a, 16b, 16c, as discussed further below.

Although posts 50 and recesses 52 may vary in number, shape, size, location, and spacing, the structures should be capable of withstanding the compressive forces on battery system 10, such as the compressive forces applied by external bands 18 around battery system 10 (FIG. 1). The ability to withstand the compressive forces on battery system 10 ensures that outer surfaces 28 of frames 20, 22 and posts 50 extending therefrom maintain their structural integrity without bending or breaking under compression. In the illustrated embodiment of FIG. 5, large, round posts 50 (shown in white) and recesses 52 (shown in gray) are arranged in a grid pattern across outer surfaces 28 of sub-assemblies 16. Some posts 50 and recesses 52 are located near outer periphery 29 of outer surface 28, while other posts 50 and recesses 52 are located inward of outer periphery 29 within central region R.

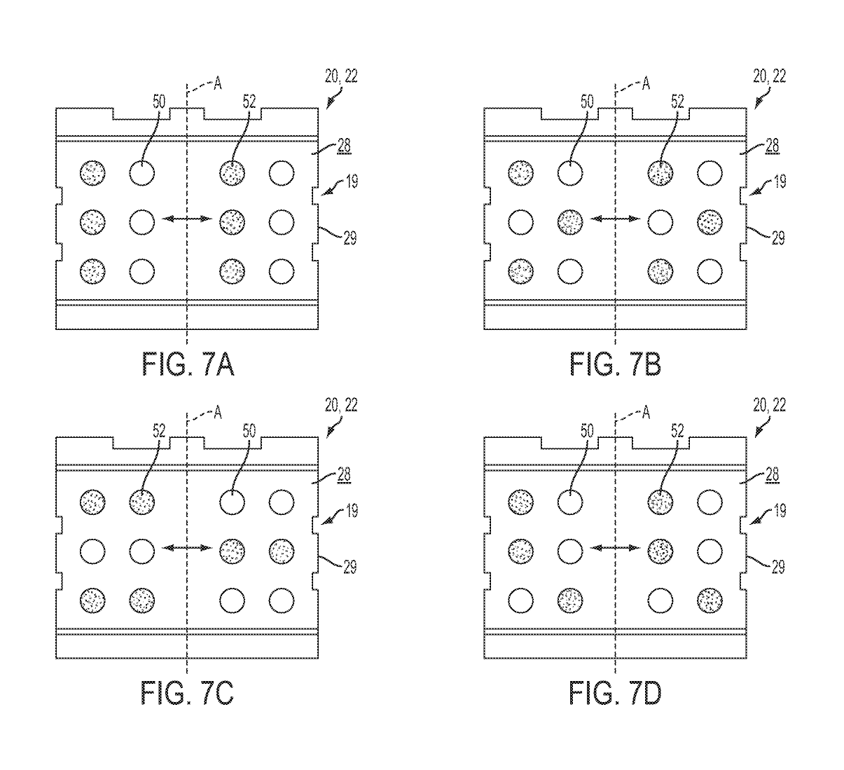

As discussed above with reference to FIGS. 6A and 6B, a single frame piece may have dual uses as left frame 20 or right frame 22. The arrangement of posts 50 and recesses 52 may facilitate these dual uses. An exemplary frame piece 20, 22 includes a combination of both posts 50 and recesses 52 on outer surface 28. These posts 50 and recesses 52 should he arranged about the axis of rotation A such that the axis A is an axis of asymmetry for posts 50 and recesses 52. From the axis A, a structure positioned a certain distance to the left of axis A should have a corresponding opposite structure positioned the same distance to the right of axis A. In FIG. 6A, for example, recesses 52 located to the left of axis A have corresponding opposite posts 50 located to the right of axis A. Other suitable arrangements of posts 50 (shown in white) and recesses 52 (shown in grey) are shown in FIGS. 7A-7D, for example. Ignoring posts 50 and recesses 52, the axis A may otherwise be an axis of symmetry through outer surface 28 and outer periphery 29 of frame 20, 22. Whether the frame piece is rotated about this axis A for use as right frame 22, as shown in FIG. 6A, or left frame 20, as shown in FIG. 6B, posts 50 on one frame piece will face and interact with recesses 52 on the other frame piece, and vice versa.

Physical contact between outer surfaces 28 of adjacent sub-assemblies 16 may be discrete or interrupted to form cooling gaps 17 therebetween. In the illustrated embodiment of FIG. 4, standoffs 54 extend from outer surfaces 28 to separate adjacent outer surfaces 28. Standoffs 54 are illustratively located at the base of each recess 52, so that recesses 52 extend beyond outer surface 28 rather than being inset entirely beneath outer surface 28. Similar standoffs 54 are also located at the base of each post 50. Depending on the height of posts 50, recesses 52, and standoffs 54, the cooling gaps 17 may vary in width from about 0.5 mm, 1.0 mm, or 1.5 mm to about 2.0 mm, 2.5 mm, or 3.0 mm, for example.

In use, air, water, or another suitable heat exchange medium may be directed through cooling gaps 17 to cool battery system 10, as shown in FIG. 3. Controlling the size of each cooling gap 17 allows one to control and balance the amount of heat exchange medium that may be directed through each cooling gap 17. Temperature sensors (e.g., thermistors) may be provided throughout battery system 10 to control the flow of the heat exchange medium and to regulate the cooling of battery system 10. In one embodiment, the thermistors are received within pockets of frames 20, 22. Other coupling features (e.g., tongues/grooves, protrusions/recesses, snaps, etc.) may also be provided on frames 20, 22 to locate and receive the thermistors. A flowing heat exchange medium may provide more efficient cooling of battery system 10 compared to a heat sink, for example.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A battery system comprising at least one battery sub-assembly, the at least one battery sub-assembly comprising:
at least one battery cell;
a first frame having an inner surface that aces the at east one battery cell and an outer surface opposite the inner surface; and
a second frame having an inner surface that faces the at least one battery cell and an outer surface opposite the inner surface, wherein the inner surfaces of the first and second frames are welded together to compress the at least one battery cell.

2. The battery system of claim 1, wherein the first and second frames are welded together without external fasteners.

3. The battery system of claim 1, wherein the first and second frames are generally planar and rectangular in shape.

4. The battery system of claim 1, wherein the first and second frames are substantially identical in size and shape.

5. The battery system of claim 1, wherein the outer surface of each first and second frame includes a recess and a protrusion, the recess and the protrusion being arranged asymmetrically on the outer surface.

6. The battery system of claim 1, further comprising a second battery sub-assembly, the at least one battery sub-assembly including at least one of a recess and a protrusion that interacts with a corresponding feature on the second battery sub-assembly.

7. The battery system of claim 1, further comprising a second battery sub-assembly, wherein the at least one battery sub-assembly and the second battery sub-assembly are at least partially spaced apart when coupled together to define a cooling gap.

8. The battery system of claim 1, further comprising a first end support and a second end support, the at least one battery sub-assembly is compressed between the first and second end supports.

9. The battery system of claim 1, wherein:
the first frame has an outer periphery and a solid central region located inward of the outer periphery; and
the second frame has an outer periphery and a solid central region located inward of the outer periphery.

10. The battery system of claim 1, wherein:
the first frame has an outer periphery, a central region located inward of the outer periphery, and at least one alignment feature located within the central region; and
the second frame has an outer periphery, a central region located inward of the outer periphery, and at least one alignment feature located within the central region.

11. A battery system comprising at least one battery sub-assembly, the at least one battery sub-assembly comprising:
at least one battery cell;
a first frame having a first outer periphery, a first central region, a first inner surface that faces the at least one battery cell and a first outer surface opposite the first inner surface, the first outer surface of the first frame having a first recess located in the first central region and a first protrusion located in the first central region that interact with a first adjacent battery sub-assembly; and
a second frame having a second outer periphery, a second central region, a second inner surface that faces the at least one battery cell and a second outer surface opposite the second inner surface, the second outer surface of the second frame having a second recess located in the second central region and a second protrusion located in the second central region that interact with a second adjacent battery sub-assembly.

12. The battery system of claim 11, wherein the first and second frames are substantially identical in size and shape.

13. The battery system of claim 11, wherein:
the first frame is rotated 180 degrees about an axis of rotation relative to the second frame; and
the first recess and the first protrusion are located on opposite sides of the axis of rotation.

14. The battery system of claim 11, wherein the first frame is rotated 180 degrees about an axis of rotation relative to the second frame, the axis of rotation forming an axis of asymmetry for the first recess and the first protrusion of the first frame.

15. The battery system of claim 11, wherein the first recess and the first protrusion are located on opposite sides of the first central region of the first frame.

16. The battery system of claim 11, further comprising:
at least one first standoff between the first frame and the first adjacent battery sub-assembly to define a first cooling gap; and
at least one second standoff between the second frame and the second adjacent battery sub-assembly to define a second cooling gap.

17. The battery system of claim 11, wherein:
the first central region of the first frame is solid, such that the first frame lacks openings between the first inner surface and the first outer surface in the first central region; and
the second central region of the second frame is solid, such that the second frame lacks openings between the second inner surface and the second outer surface in the second central region.

18. The battery system of claim 11, wherein:
the at least one battery cell includes an outer seal portion and an inner body portion;
the first and second outer peripheries of the first and second frames overlap the outer seal portion of the at least one battery cell; and
the first and second central regions of the first and second frames overlap the inner body portion of the at least one battery cell.

19. The battery system of claim 11, wherein:
the first recess and the first protrusion of the first frame are located closer to a center of the first frame than to the first outer periphery of the first frame; and
the second recess and the second protrusion of the second frame are located closer to a center of the second frame than to the second outer periphery of the second frame.
